(19) United States
(12) Patent Application Publication
(10) Pub. No.: US 2022/0219815 A1
(43) Pub. Date: Jul. 14, 2022

(54) Unmanned Aerial Drone Crane

(71) Applicant: Jimmy R. Bryson, Daytona Beach, FL (US)

(72) Inventor: Cade CIRIPOMPA, Daytona Beach, FL (US)

(21) Appl. No.: 17/229,172

(22) Filed: Apr. 13, 2021

Related U.S. Application Data
(60) Provisional application No. 63/135,191, filed on Jan. 8, 2021.

(51) Int. Cl. B64C 27/72; B64C 39/02; B64C 27/46

(52) U.S. Cl. CPC B64C 27/72; B64C 39/024; B64C 27/463; B64D 1/22; B64C 2201/108; B64C 2201/128; B64C 2201/027

(57) ABSTRACT

A UAV preferably has 6 rotors mounted on an H-Frame setup with two parallel longitudinally extending support beams with a cross beam. The rotors are mounted along the longitudinal extending support beams, with one rotor mounted at each end and one motor mounted at the cross beam. Such an arrangement is more efficient than a helicopter of similar disk size and will be more efficient than a traditional hex rotor setup when lifting heavy payloads at a construction site.

### BACKGROUND OF THE INVENTION

The present invention pertains to multi rotor unmanned aerial vehicles (UAVs) capable of lifting heaving payloads. UAVs are becoming increasingly common. UAVs are employed in many different industries and, as explained below, are needed in some cases to replace cranes in a construction site.

Typically, UAVs have four rotatable propellers and are designed for vertical takeoff. However, some UAVs have fixed wings and other UAVs have additional rotatable propellers. Each propeller is usually powered by a separate motor attached to a central frame. The frame carries a controller that is electronically connected to each motor and is also connected to a communications system that receives control instructions from a ground-based controller or a user interface. The UAV can, therefore, be controlled remotely by someone who is on the ground employing the user interface. In other words, there is no need to have a pilot physically on board. The UAV is controlled from the ground and in some cases the UAV has a certain degree of autonomous control. For example, the UAV is often able to hover on its own without continuous input from the user interface.

Controlling UAVs is accomplished by varying the speed of each motor which in turn varies the speed of each propellor. The propellors on one side of the vehicle usually counterrotate versus the propellors on the opposite side, while the propellors on the same side of the UAV rotate in the same direction. Hovering in place is achieved by having the propellors rotate at the same speed with just enough lift to counter the weight of the vehicle. Roll, pitch and yaw are controlled by changing the speeds of each propellor. Various protocols for moving a UAV by adjusting individual rotor speed are known in the art.

The motors are often brushless direct current motors since such motors have a high power to weight ratio and are relatively easy to control. Power for the motors is provided by a battery mounted on the central frame. The batteries are usually made of lithium due to weight considerations.

Some UAVs are provided with cameras and are therefore able to capture video that cannot otherwise easily be obtained. Diverse groups from law enforcement, oil platform workers and the military all take advantage of the ability of UAVs to take pictures while flying. The safety of the workers is improved as the UAV can enter a dangerous area to take pictures so that a person no longer has to do so. For example, instead of hanging on a rope off of an oil drilling platform to take pictures while searching for structural damage, a UAV can be sent instead. UAVs are also now being used to deliver packages or payloads. However, there is a demand in the industry for delivering payloads not only from central distribution points to customers but also in a construction site to a desired location. The payloads involved tend to be heavy and, therefore, most UAV designs simply cannot lift sufficient weight to meet the demands of industry. While helicopters have been used in place of cranes, such helicopters have particularly large rotors to enable them to lift heavy loads.

Vertical takeoff and landing (VTOL) vehicles are aircraft that can take off like a helicopter but fly like a plane, which improves long distance efficiency and airspeed. A helicopter or multirotor is not very efficient in getting from point A to point B, and they are especially not fast at it. Hundreds of organizations have developed various VTOL aircraft concepts. Some though simply adapt lifting surfaces (wings) to existing multirotor frames and add a ‘pusher motor’ to propel the aircraft forward; the multirotor rotors stop once the aircraft's forward speed creates enough lift on its lifting surfaces. By contrast most UAVs are designed to take advantage of four small propellers that provide agility at a relatively inexpensive cost.

Accordingly, there is a need in the art for a UAV that can carry large amounts of weight especially one that can lift a payload to a desired location in a construction site.

### SUMMARY OF THE INVENTION

Preferably a drone crane is provided with an H-Frame setup that is provided with two parallel longitudinally extending supports or beams with a cross beam. The rotors are mounted along the longitudinal extending supports, with one rotor mounted at each end and one rotor mounted at the cross beam. Alternatively, additional cross beams may be added at the ends of the longitudinal beams and the motors can be placed at the ends of the laterally extending cross beams. The subject unmanned aerial drone crane preferably will have a minimum of 6 rotors. Larger versions of the drone crane will preferably have 6 or possibly 8 rotors. Such an arrangement is more efficient than a helicopter of similar disk size and is more efficient than a traditional hex rotor setup with a circular pattern of rotors.

For example, in one preferred embodiment, the drone crane comprises a frame including a pair of longitudinal beams each having a first end, a second end, an upper surface and a lower surface. A first lateral beam is connected to the lower surface of the longitudinal beams at the first end. A second lateral beam is connected to the lower of the longitudinal beams at the second end. A third lateral beam is connected to the upper surface of the longitudinal beams between the first end and the second end. The drone crane also comprises a first propulsion unit mounted to an end of the first lateral beam. The propulsion unit includes a first motor configured to operate at a plurality of speeds, a shaft rotated by the motor and a first propeller mounted above the first lateral beam and rotatably coupled to the first motor via the shaft. The propulsion unit has a first hub and a first plurality of blades mounted on the hub. The blades have a pitch that is varied. A second propulsion unit is mounted to an end of the second lateral beam of the frame and includes a second propeller with a second set of blades, mounted above the second lateral beam and rotatably coupled to a second motor. A third propulsion unit is mounted to an end of the third lateral beam of the frame and includes a third propeller mounted above the third lateral beam. A third plurality of blades from the third propeller has blade tips configured to create blade tip vortices that act on the first and second plurality of blades of the first and second propellers.

The first propulsion unit further comprises a servo motor driving a pinion mounted for connection with a rack gear, whereby rotation of the servo motor varies the pitch of the first plurality of blades. The first propulsion unit further comprises a pitch slider connected to the rack gear and a plurality of pitch links extending between the pitch slider and a plurality of pitch levers. The pitch levers are configured to rotate the blades in response to movement of the pitch slider thus providing dramatically varying the lift.

The center pair of rotors is preferably positioned above the outer two pairs for two purposes: this arrangement allows the center beams to carry a load, with the two frame beams beneath the center beam, and the two outer beams beneath the longitudinal beams so that all lifting forces are translated against the beams/frames rather than relying on the strength of any fasteners. This arrangement also allows for a more efficient aircraft since the blade tip vortices from the center pair of rotors will act on both pairs of outboard rotors. This arrangement will increase the lift on the outer rotors, interrupt and reduce their own tip vortices, and reduce drag on the outer rotors therefore increasing efficiency. The drone cranes will be tethered to their payload via a sling or cable and have fixed landing gear on the frame. Such UAVs, when adapted, act as unmanned aerial drone cranes and are able to lift heavy payloads to desired locations within the construction site.

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

FIG. 1 is a perspective view of drone crane having a frame supporting multiple propellor assemblies constructed in accordance with the present invention;

FIG. 2 is a schematic view of a control system for the drone crane of FIG. 1;

FIG. 3 is a prospective view of one of the propellor assemblies of the unmanned aerial vehicle of FIG. 1.

FIG. 4 is a side view of the propellor assembly of FIG. 3;

FIG. 5 is an exploded view of the propellor assembly of FIG. 4

FIG. 6 is a close-up view of the propellor assembly of FIG. 3, with the frame removed for clarity;

FIG. 7 is an exploded view of the propellor mount of the propeller assembly of FIG. 5.

### DETAILED DESCRIPTION OF THE PREFERRED EMBODIMENTS

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting but merely as a representative basis for teaching one skilled in the art to variously employ the present invention.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. Any numerical values given herein should also be understood to include about or approximately that value, unless the context indicates otherwise. Any numerical range recited herein is intended to include all sub-ranges subsumed therein.

The following detailed description should be read with reference to the drawings in which similar elements in different drawings are numbered the same. The detailed description and the drawings, which are not necessarily to scale, depict illustrative embodiments and are not intended to limit the scope of the disclosure. Instead, the illustrative embodiments depicted are intended only as exemplary. Selected features of any illustrative embodiment may be incorporated into another embodiment unless clearly stated to the contrary. While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents and alternatives falling within the spirit and scope of the disclosure.

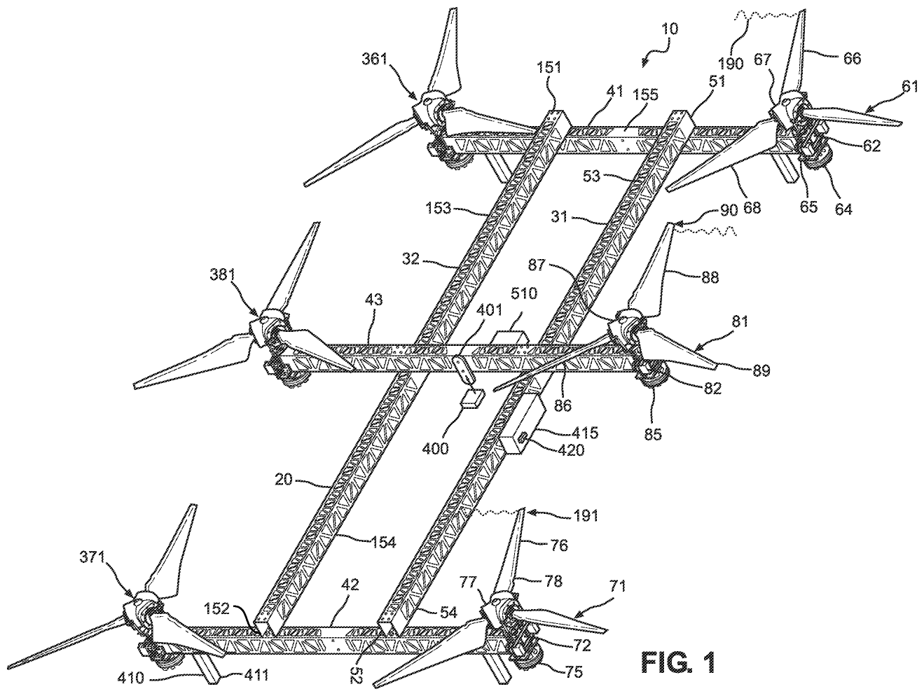

With initial reference to FIG. 1 there is shown an unmanned aerial vehicle (UAV) or drone crane 10 in accordance with a preferred embodiment of the invention. Drone crane 10 has a main frame 20 that is formed with first and second longitudinal beams 31 and 32 and three lateral beams 41, 42 and 43. More specifically, frame 20 includes a longitudinal beam 31 having a first end 51, a second end 52, an upper surface 53 and a lower surface 54. First lateral beam 41 is connected to lower surface 54 of longitudinal beam 31 at first end 51. A second lateral beam 42 is connected to lower surface 54 longitudinal beam 31 at second end 52. A third lateral beam 43 is connected to upper surface 53 of longitudinal beam 31 between first end 51 and second end 52.

Drone crane 10 also comprises a first propulsion unit 61 mounted to an end 62 of first lateral beam 41. First propulsion unit 61 includes a first motor 64 configured to operate at a plurality of speeds. Motor 64 is securely attached to first lateral beam 41 with a mounting plate 65. A first propeller 66, mounted above first lateral beam 41 is rotatably coupled to first motor 64. First propeller 66 has a first hub 67 and a first plurality of blades 68 mounted on hub 67. First plurality of blades 68 has a pitch that is varied. A second propulsion unit 71 is mounted to an end 72 of second lateral beam 42. Second propulsion unit 71 includes a second motor 75 configured to operate at a plurality of speeds, a second propeller 76, mounted above second lateral beam 42 and rotatably coupled to second motor 75 and having a second hub 77 and a second plurality of blades 78 mounted on second hub 77. A third propulsion unit 81 is mounted to an end 82 of third lateral beam 43 and includes a third motor 85 configured to operate at a plurality of speeds. A third propeller 86 is mounted above third lateral beam 43 and is rotatably coupled to third motor 85 and having a third hub 87 and a third plurality of blades 88 mounted on the third hub and having blade tips 89 configured to create blade tip vortices 90 that act on the first and second plurality of blades 68, 78.

Second longitudinal beam 32 also has a first end 151, a second end 152, an upper surface 153 and a lower surface 154. Second longitudinal beam 32 connected to first lateral beam 41, second lateral beam 42 and third lateral beam 43. Upper surface 155 of first lateral beam 41 supports lower surface 154 of second longitudinal beam 32 and upper surface of second lateral beam 42 supports the lower surface of second longitudinal beam 32. The first, second and third plurality of blades 68, 78, and 88 are configured to cause blade tip vortices 90 of third plurality of blades 88 to reduce blade tip vortices 190, 191 formed by the first and second plurality of blades 68, 78.

Referring back to FIG. 1, there are shown three additional propulsion units 361, 371 and 381 which are similar to the first second and third propulsion units 61, 71 and 81, and preferably include similar or identical features (e.g., power sources, numbers of poles, whether the motors included therein are synchronous or asynchronous) or operational capacities (e.g., angular velocities, torques, operating speeds or operating durations). Each of such propulsion units 61, 71, 81, 361, 371, and 381 may be operated individually or in tandem with one another, for any purpose. For example, two or more of the propulsion units 61, 71, 81, 361, 371, and 381 may be operated to provide both lift and thrust in the form of a thrust vector that changes as the drone cranes's attitude changes, while two or more of propulsion units 61, 71, 81, 361, 371, and 381 may be operated to provide forward motion. Motor 64 may be any type or form of motor (e.g., electric, gasoline-powered or any other type of motor) capable of generating sufficient rotational speeds of the corresponding to provide lift and/or thrust forces to drone crane 10 and any engaged payload 400 supported by payload bracket 401, and to aerially transport the engaged payload 400. For example, motor 64 preferably includes a brushless direct current (DC) motor.

The drone is equipped with landing gear 410. As shown landing struts 411 are located in a rectangular pattern and are attached to the laterally first and second extending beams 41, 42. As shown landing struts 411 are fixed. Preferably, landing struts 411 are long enough so that load 400 carried by drone crane 10 will not touch the ground when drone crane 10 has landed. However, the landing struts 411 could be shorter for when drone crane 10 will pick up and drop off payload 400 supported by a sling while flying. Landing struts 411 could also be retractable. Details of such a landing gear can be found in U.S. Patent Application Publication No. 2018/0281933 incorporated herein by reference.

A power source or battery 415 is also provided. Battery 415 may be centrally located on longitudinal beams 31, 32 and contains a plurality of stacks of lithium battery cells 420. Alternatively, battery 415 is comprised of multiple smaller cells (not shown) each located on lateral beams 41, 42 to reduce the length of cable from the cells to the propulsions unit, thus providing redundancy while increasing efficiency and decreasing weight. Preferably battery 415 is a rechargeable smart battery having a controller 421 that tracks battery usage, charging and temperature. More details of a rechargeable battery for a drone are found in U.S. Patent Application Publication No. 2019/0233100 incorporated herein by reference.

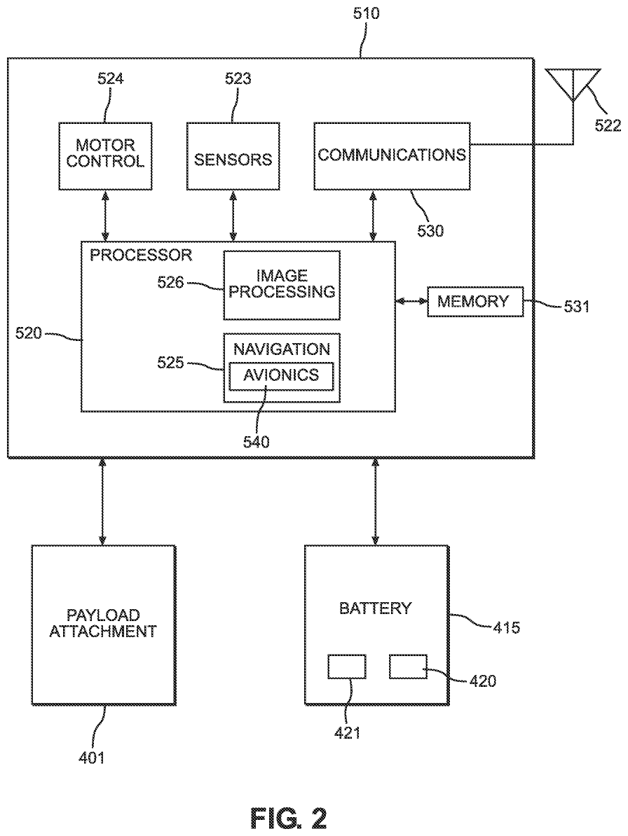

Frame 20 preferably supports a control unit 510 in addition to, propulsion units 61, 71, 81, 361, 371, and 381, battery 415 payload securing bracket 401, and other components. FIG. 2 schematically illustrates components of a control unit 510 and associated components mounted on frame 20. Control unit 510 has a central processing unit 520 one or more radio antennas 522 and sensors 523. Central processing unit 520 includes executable instructions to control flight and other operations of drone crane 10. In some embodiments, the central processing unit 520 is operationally connected to payload bracket 411 and landing struts 411 to allow drone crane 10 to release a payload. Processor 520 is powered from battery 415. Central processing unit 520 is preferably coupled to a motor control system 524 that is configured to manage propulsion units 61, 71, 81, 361, 371, and 381.

Through control of the individual propulsion units 61, 71, 81, 361, 371, and 381, drone crane 10 is controlled in flight. In the central processor 520 there is located a navigation controller 525 configured to determine the present position and orientation of drone crane 10, the appropriate course towards a destination, etc.

Optionally a camera apparatus 526 is coupled to drone crane 10 for providing image data to an image processing system 526 within or coupled to the processor 520. Image processing system 526 is preferably a separate image processor, such as an application specific integrated circuit, configured for processing images, such as stitching together images. Alternatively, image processing system 526 is implemented in software executing within the processor 520.

Control unit 510 preferably includes one or more transceivers 530, which may be coupled to an antenna 522. Transceiver 530 is preferably capable of communication with other drones, smart phones, a drone controller and other devices or electronic systems. Transceiver 530 may include a GPS receiver configured to provide position information to navigation unit 525 and include a GNSS receiver configured to provide three-dimensional coordinate information to drone crane 10 by processing signals received from three or more GNSS satellites. Navigation controller 525 may use an additional or alternate source information from processed images to determine speed and direction of travel and attitude information by processing images of the ground.

An avionics component 540 of navigation controller 525 may be configured to provide flight information, such as altitude, attitude, airspeed, heading and similar information that may be used for navigation purposes. Navigation controller 525 may include or be coupled to sensors 523 configured to supply data to navigation controller 525. For example, sensors 523 could include one or more accelerometers or gyroscopes to provide information to the navigation unit. Sensors 523 could also include barometers, thermometers, audio sensors, motion sensors, etc. Sensors 523 may provide information regarding accelerations and orientation (e.g., with respect to the gravity gradient and earth's magnetic field) to enable navigation controller 525 to perform navigational calculations of drone crane 10 during flight. A barometer may provide ambient pressure readings used to approximate elevation level (e.g., absolute elevation level) of drone crane 10.

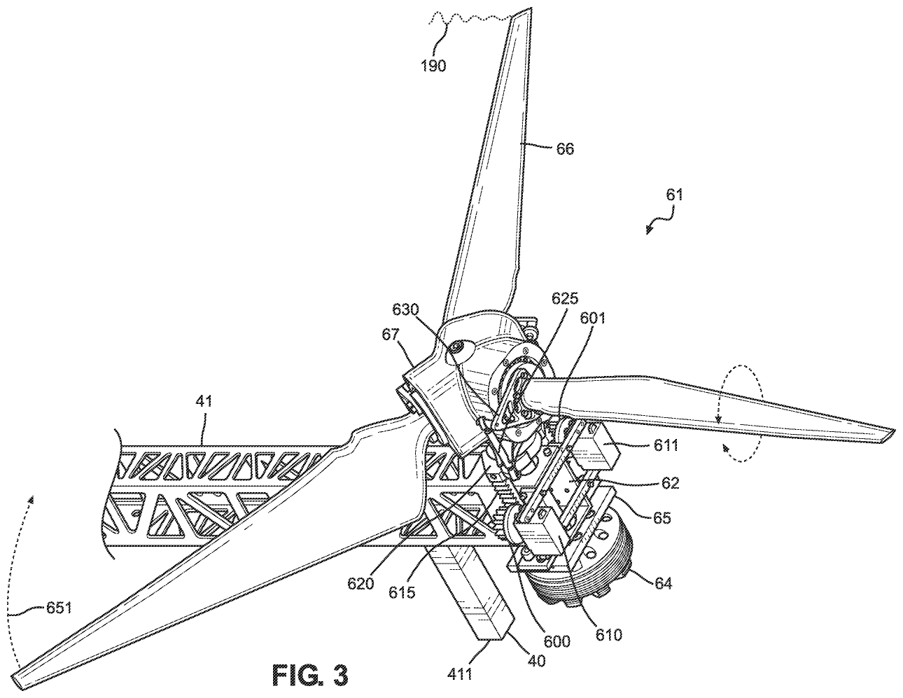

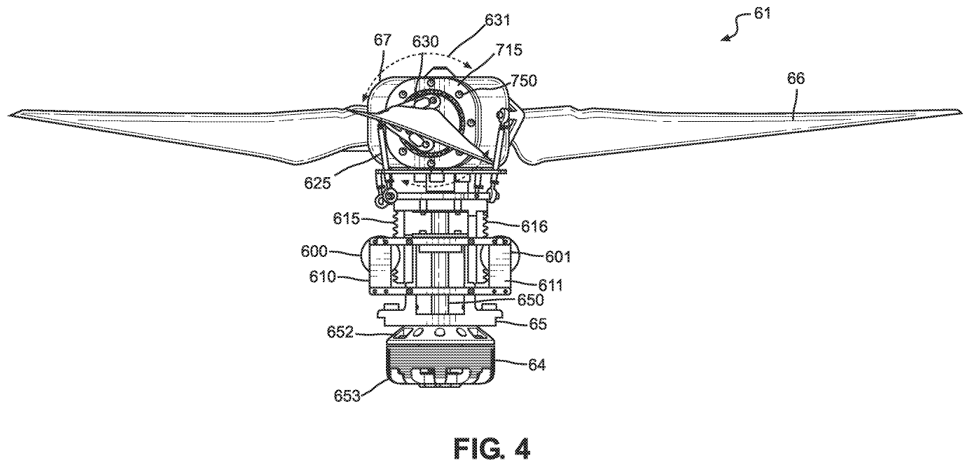

The details of propulsion unit 61 can be best seen in FIGS. 3-6. First propulsion unit 61 has first and second pinions 600, 601 driven by a first and second pinion motors 610, 611. First and second pinion motors 610, 611 are each preferably an electric servo motor mounted on end 62 of first lateral beam 41. Preferably pinion motors 610, 611 are provided with splined output shafts. Each output shaft has splines that mate with corresponding internal splines located on mounting horns (not separately shown). The horns have a standard bolt pattern to allow pinions 600, 601 to be secured on the shafts so that motors 610, 611 can drive pinions 600, 601. First pinion 600 is drivingly connected with a first rack gear 615 and second pinion 601 is connected with a second rack gear 616 (FIG. 4). Specifically, teeth (not separately labelled) are formed on pinions 600, 601 and are engaged with teeth (not separately labelled) on gear racks 615, 616 whereby rotation of pinions 600, 601 move rack gears 615, 616 up or down relative to drone crane 10. Pinions 600, 601 are preferably made of aluminum alloy. Rack gears 615, 116 are preferably made of a high-density polymer to eliminate wear between pinions 600, 601 and rack gears 615, 116. Alternatively, rack gears 615, 116 could be made from bronze or brass instead of a polymer. The interaction between the polymer and aluminum allows for a long mechanism life, without any loss of precision from wear. Rack gears 615, 116 are connected to pitch slider 620 which in turn is connected to a plurality of pitch links, one of which is labelled 625. Pitch link 625 is connected to a pitch lever 630. First propulsion unit 61 further comprises a pitch slider 620 connected to rack gear 615 and a plurality of pitch links 625 extending between pitch slider 620 and a plurality of pitch levers 630 connected to blades 66. Pitch lever 630 is configured to rotate the pitch of blades 68 as shown by arrow 631 (FIG. 4) in response to movement of pitch slider 620 while motor 64 is connected to hub 67 by shaft 650 so as to rotate blades 68 so that blades 68 can provide lift for drone crane 10. Rack gears 615, 116 pinion motors are rotary servos, when rotary servos fail, they spin freely. In addition, each servo pinion motor 610, 611 is configured to be powerful enough to be able to move pitch slider 620 even when only one of pinion motors 610 and 611 are working. In other words, the pinion motors have enough power to overcome drag caused by a failed motor and still drive pitch slider 620. By contrast if linear actuators were employed and one failed, pitch slider 620 would not be able to move as the failed linear actuate would lock up and not move. Rack gears 615, 116 are configured to prevent pitch slider 620 from rotating with hub 67. The polymer composition of rack gears 615, 116 allows a sliding connection between rack gears 615, 116 and frame 20. Essentially the polymer allows rack gears 615, 116 to act as a bushing. Rack gears 615, 116 have a curved shape as does pitch slider 620. The curved shape forces rack gears 615, 116 into alignment with pitch slider 620.

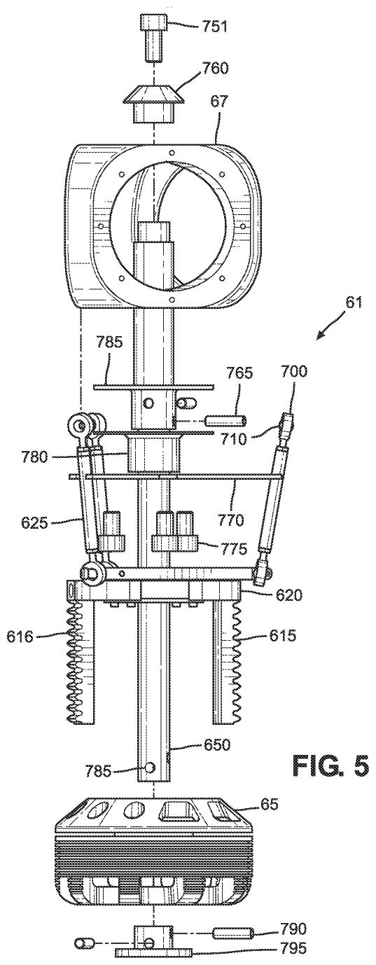

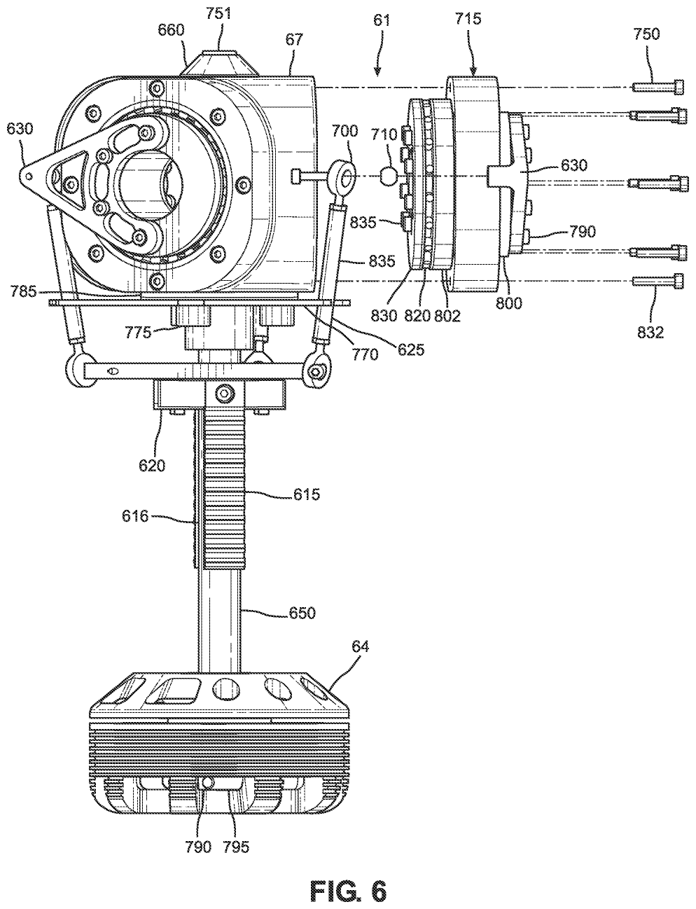

FIG. 3 showing a side view and FIGS. 5 and 6 showing exploded views of propulsion unit 61 to make clearer the details of how pitch link 625 is connected to a pitch lever 630 and also how motor 64 is connected to hub 67 and a shaft 650. Motor 64 has a stationary portion 652 attached to plate 65 and a rotary portion 653 attached to shaft 650 which can rotate as shown by arrow 651 (FIG. 3). With reference to FIG. 5, gear racks 615, 616 are both connected to pitch slider assembly 620 which is connected to several pitch links including pitch link 625 which is a turnbuckle linkage having Hiem joints located at each end, an upper hiem joint 700 and lower hiem joint 701. Upper hiem joint 700 has a hiem ball 710 which connects pivotably to pitch lever 630, which in turn is mounted on blade cuff and spacer assembly 715. Motion of pitch slider assembly 620 is transferred by pitch links 625 to pitch lever 630 and then to blades 66. Spacer assembly 715 is fastened to hub 67 by fasteners 750 and supports one of the blades 66, best seen in FIG. 4.

Turning back to FIGS. 5 and 6, a threaded fastener 751 is configured to pass through a hub cap 760 and into shaft 650 and thereby secure hub 67 to shaft 650. A phasing plate 770 is connected to pitch links 625 and is secured to hub 67 by fasteners 775. Phasing plate 770 ensures that pitch links 625 and pitch lever arms 630 all work in unison to provide blades 66 with the same amount of pitch. Plate 770 also traps pitch links 625 to keep them rotating in unison with the rest of the propeller. Otherwise, the pitch of one of the blades 66 could be altered by just the spinning of hub 67.

A hub coupler 785 is connected to shaft 650 by hub retaining pins 765. Hub 67 is trapped between hub cap 760 and hub coupler 785. Shaft 650 is provided with motor coupler retaining pin holes 785. When assembled, shaft 650 passes through motor 64 motor coupler retaining pins pass into a motor coupler and then into the motor coupler retaining pin holes 785 to secure the motor to shaft 650. Shaft 650 is connected to hub 67 which supports blades 66 by a blade cuff and spacer assembly 715.

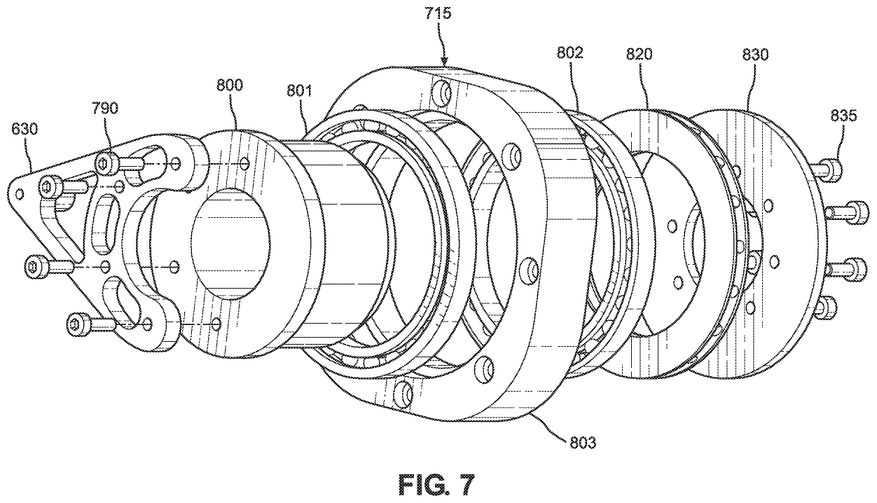

Blade cuff and spacer assembly 715 is one of three assemblies mounted on hub 67. Blade cuff and spacer assembly 715 is shown separated from hub 67 at the upper right of FIG. 6 with pitch arm 630 spaced away from hub 67. In FIG. 7, blade cuff and spacer assembly 715 is rotated so that pitch arm 630 is located to the left. With reference to both FIGS. 6 and 7, blade cuff and spacer assembly 715, lever pitch arm 630 is provided with fasteners 790 that mount lever pitch arm 630 to blade cuff 800. Blade 66 is removed for clarity but can be seen in FIG. 4. Blade cuff 800 is rotatably mounted in radial bearings 801 and 802 so as to be rotatably secured in cuff spacer 803. A thrust bearing 820 is held in place by a thrust retainer plate 830 and fasteners 835. Preferably retainer plate 830 is made of steel and fasteners 835 are 8 bolts which pass through retainer plate 830 and into cuff 800. As such steel retainer plate 830 sits against thrust bearing 820 in assembly 715 followed by radial bearing 802. All three of these pieces sit flush against a hub side of blade cuff 800 and are sized to be inserted into rotor hub 67 by a tight fit. On the side of blade cuff and spacer assembly 715 facing away from rotor hub 67, preferably fasteners 790 are four bolts that mount pitch arm 630. Radial bearing 801 is pressed into cuff spacer 803. Preferably blade 66 is made from a composite material employing carbon fiber. Blade 66 is adhered to the inside of blade cuff 800 with adhesive and three titanium pins, not shown. Since radial bearing 802 is free to slide on blade cuff 800, blade cuff 800 acts as a spacer between bearings 801 and 802 so that the need for shims is reduced. Also, alignment pins between blade cuff 800 and hub 67 are needed as bearings 801, 802 and 820 force blade cuff 800 into proper alignment with hub 67 This arrangement allows motor 64 to drive blades 66 in a rotational manner to provide lift for drone crane 10 while also allowing blades 66 to vary their pitch angle.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

For example, with minor modifications, namely a specific non-slung payload mount, drone crane has the potential to be an extremely powerful and nimble aircraft. The drone crane can support a 400 lb payload with a 2.0× safety factor. This safety factor could not only be drastically reduced for military use, but simply reducing the payload carried would allow the aircraft to operate at far greater speeds than in ‘crane configuration’. Alternative rotor blades could also be designed that have a symmetrical airfoil. The total lifting capacity would be slightly reduced, but the drone would then have the ability to fly inverted and perform maneuvers that create immense G-Forces that most other aircraft and pilots cannot withstand. This still allows the entire aircraft and payload to weigh at least as much as 400 lbs. A VTOL aircraft with this mass would become one of the largest and most capable in its class.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

As can be seen from the above description a drone crane has been described that can lift a large payload at a worksite with low risk to work crews working at the site. The drone takes advantage of rotor placement to increase lift and payload capacity. The drone also provides a mechanism to rotate blade pitch which also increases payload capacity.

1. An unmanned aerial vehicle comprising:
a frame including a longitudinal beam having a first end, a second end, an upper surface and a lower surface and a first lateral beam connected to the lower surface of the longitudinal beam at the first end, a second lateral beam connected to the lower surface the longitudinal beam at the second end and a third lateral beam connected to the upper surface of the longitudinal beam between the first end and the second end;
a first propulsion unit mounted to an end of the first lateral beam of the frame and including a first motor configured to operate at a plurality of speeds, a shaft rotated by the motor, a first propeller, mounted above the first lateral beam rotatably coupled to the first motor via the shaft and having a first hub and a first plurality of blades mounted on the hub, the blades having a pitch that is varied by a rack gear;
a second propulsion unit mounted to an end of the second lateral beam of the frame and including a second motor configured to operate at a plurality of speeds, a second propeller, mounted above the second lateral beam and rotatably coupled to the second motor and having a second hub and a second plurality of blades mounted on the second hub;
a third propulsion unit mounted to an end of the third lateral beam of the frame and including a third motor configured to operate at a plurality of speeds, a third propeller mounted above the third lateral beam and rotatably coupled to the third motor and having a third hub and a third plurality of blades mounted on the third hub and having blade tips configured and located to create blade tip vortices that act on the first and second plurality of blades.

2. The unmanned aerial vehicle of claim 1, further comprising a second longitudinal beam having a first end, a second end, an upper surface and a lower surface, said second longitudinal beam connected to the first lateral beam, second lateral beam and third lateral beam.

3. The unmanned aerial vehicle of claim 1, wherein the upper surface of the first lateral beam supports the lower surface of the longitudinal beam and the upper surface of the second lateral beam supports the lower surface of the longitudinal beam.

4. The unmanned aerial vehicle of claim 1, wherein the first, second and third plurality of blades are configured to cause the blade tip vortices of the third plurality of blades to reduce blade tip vortices formed by the first and second plurality of blades.

5. The unmanned aerial vehicle of claim 1, wherein the first propulsion unit further comprises a pinion motor driving a pinion mounted for connection with the rack gear, whereby rotation of the pinion motor varies the pitch of the first plurality of blades.

6. The unmanned aerial vehicle of claim 5, wherein the first propulsion unit further comprises a pitch slider connected to the rack gear and a plurality of pitch links extending between the pitch slider and a plurality of pitch levers.

7. The unmanned aerial vehicle of claim 6, wherein the pitch levers are configured to rotate the blades in response to movement of the pitch slider.

8. The unmanned aerial vehicle of claim 7, wherein the first propulsion unit further comprises a pitch slider connected to a second rack gear and the pitch slider.

9. The unmanned aerial vehicle of claim 8, wherein the first propulsion unit further comprises a second pinion motor and pinion connected to the rack gear.

10. A first propulsion unit configured to be mounted to an end of a first lateral beam of a frame of an unmanned aerial vehicle, said propulsion unit including a first motor configured to operate at a plurality of speeds, a shaft rotate by the motor, a first propeller, mounted above the first lateral beam rotatably coupled to the first motor via the shaft and having a first hub and a first plurality of blades mounted on the hub, the blades having a pitch that is varied by a rack gear.

11. The unmanned aerial vehicle of claim 10, wherein the first propulsion unit further comprises a pinion motor driving a pinion mounted for connection with the rack gear, whereby rotation of the pinion motor varies the pitch of the first plurality of blades.

12. The unmanned aerial vehicle of claim 11, wherein the first propulsion unit further comprises a pitch slider connected to the rack gear and a plurality of pitch links extending between the pitch slider and a plurality of pitch levers.

13. The unmanned aerial vehicle of claim 12, wherein the pitch levers are configured to rotate the blades in response to movement of the pitch slider.

14. The unmanned aerial vehicle of claim 13, wherein the first propulsion unit further comprises a pitch slider connected to a second rack gear and the pitch slider.

15. The unmanned aerial vehicle of claim 14, wherein the first propulsion unit further comprises a second pinion motor and pinion connected to the rack gear.
